(19) United States
(12) Patent Application Publication
(10) Pub. No.: US 2024/0211555 A1
(43) Pub. Date: Jun. 27, 2024

(54) AUTOMATION TECHNOLOGY FIELD DEVICE AND METHOD FOR SAFE OPERATION OF A FIELD DEVICE

(71) Applicant: Endress+Hauser Conducta GmbH+Co. KG, Gerlingen (DE)

(72) Inventors: Martin Lohmann, Gerlingen (DE); Thomas Alber, Stuttgart (DE); Oliver Durm, Benningen am Neckar (DE); Roman Griesser, Gerlingen (DE); Björn Haase, Stuttgart (DE); Stefan Robl, Hünxe (DE); Karsten Traub, Bietigheim-Bissingen (DE)

(21) Appl. No.: 18/389,950

(22) Filed: Dec. 20, 2023

(30) Foreign Application Priority Data
Dec. 21, 2022 (DE) 10 2022 134 322.7

(51) Int. Cl. G06F 21/31

(52) U.S. Cl. CPC G06F 21/31

(57) ABSTRACT

The invention relates to a field device of automation technology, wherein the field device has at least one sensor designed to detect a physical, chemical, or biological variable of a process engineering process and/or at least one actuator designed to influence a physical variable of a process engineering process, or such a sensor and/or actuator is assigned to the field device, wherein the field device has at least one electronics unit for operating the field device, wherein at least two operating phases are defined in the field device, wherein one or more authorization information items are assigned to each of the operating phases, wherein the authorization information items define at least one user authorized to access the field device and/or at least one permitted operating action on the field device, and wherein the electronics unit is designed to operate the field device in a current operating phase, wherein the current operating phase is one of the defined operating phases, as well as to a method for safe operation of such a field device.

### CROSS REFERENCE TO RELATED APPLICATION

The present application is related to and claims the priority benefit of German Patent Application No. 10 2022 134 322.7, filed on Dec. 21, 2022, the entire contents of which are incorporated herein by reference.

### TECHNICAL FIELD

The invention relates to an automation technology field device. The invention further relates to a method for safe operation of a field device.

### BACKGROUND

In automation technology, in particular in its subfields process automation and manufacturing automation, field devices for detecting and/or influencing physical, chemical, or biological process variables are often used. Measuring devices are used for detecting process variables. These measuring devices are used, for example, for pressure and temperature measurement, conductivity measurement, flow measurement, pH measurement, fill level measurement, etc., and detect the corresponding process variables of pressure, temperature, conductivity, pH value, fill level, flow, etc. Actuator systems are used for influencing process variables. Examples of actuators are pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level. Field devices are, generally speaking, devices which are used in the vicinity of the process or of the plant and which supply or process information relevant to process or plant.

If a field device is to be serviced or repaired, a service technician receives an appropriate work order. The work order is handed over by hand or it reaches the service technician via a suitable system, for example an asset management system or an ERP system. However, the system may well still be a card index box as well.

Each field device in automation technology usually has a permanently available operating interface (or access interface) via which the field device can be operated. The term “operation of the field device” in connection with the invention is to be interpreted broadly. The operation may thus be a function test, a parameterization or calibration process, or a repair of the field device. However, the operation of the field device may also include augmenting a parameter, installing a software/firmware update, or simply displaying desired information from the field device. A service technician uses this access to perform the work order. After completion of the work order, the access to the field device remains unchanged.

The permanent access to the field device can be protected via user management and/or access control. The access control can be performed by inputting a PIN or a password, or by reading information stored on an RFID chip, so that only certain persons or groups of people receive access to a field device. In many cases, however, the permanent access to the field devices is completely unprotected.

Consider the case where access to a field device with user management and/or access control is permanently available. If the user has access authorization, he can operate the field device without restriction. Authorization to perform a single specific work order does not exist. Consequently, it is possible for each authorized user to, inadvertently or intentionally, adjust and/or manipulate the field device further, even beyond the scope of the actual work order.

Nowadays, there are solutions that include a user management system. DE 10 2019 131 860 A1, for example, describes a method in which order tickets are created, which order tickets are used by service technicians to log on to the field device and which order tickets are used to define the service technician's authorizations (e.g., the right to perform certain operating actions on the field device). However, the access rights and access restrictions in the solutions known today relate solely to the configured user, who can operate a device with partial or full scope, in accordance with their rights. These access rights and restrictions are permanently available.

### SUMMARY

The invention is based on the object of further securing access to a field device for the purpose of operating the field device.

The object is achieved by a field device of automation technology according to claim 1, and by a method according to claim 10. Advantageous embodiments are specified in the subclaims.

With regard to the automation technology field device, it is provided wherein the field device has at least one sensor designed to detect a physical variable of a process engineering process and/or at least one actuator designed to influence a physical variable of a process engineering process, or such a sensor and/or actuator is assigned to the field device, wherein the field device has at least one electronics unit for operating the field device, wherein at least two operating phases are defined in the field device, wherein one or more authorization information items are assigned to each of the operating phases, wherein the authorization information items define at least one user authorized to access the field device and/or at least one permitted operating action on the field device, and wherein the electronics unit is designed to operate the field device in a current operating phase, wherein the current operating phase is one of the defined operating phases.

According to the invention, it is provided that access authorizations and access restrictions are defined in such a way that they can be changed over time. For this purpose, it is provided that a plurality of operating phases are assigned to the field device, wherein, depending on the current operating phase in which the field device is currently being operated, the authorization information items, which contain access authorizations and restrictions, change. This ensures that only the operating actions permitted in the respective operating phase can be carried out at the field device and/or that these operating actions can only be carried out by a specific user or a specific user group, thereby increasing operational safety.

Examples of field devices that can implement the invention have already been described in the introductory part of the description.

According to an advantageous design of the field device, it is provided that the electronic unit is designed to check an access request to determine whether information items contained in the access request regarding the user and/or contained operating actions are contained in the authorization information items assigned to the current operating phase. The access request is only permitted if the check is successful. This means that the information items contained in the access request regarding the user and/or contained operating actions are actually contained in the authorization information items assigned to the current operating phase—for example, a user may perform certain operating actions on the field device if at least one of the authorization information items in which his information is contained is assigned to the current operating phase.

Advantageously, the electronics unit of the field device according to the invention is designed to change the current operating phase. “Change” in this sense means that the current operating phase in which the field device is operated is replaced with one of the defined operating phases that is not the current operating phase. The current authorization information items are thereby changed, since only those authorization information items which are assigned to the new current operating phase are valid. A user can thus completely lose access, or other operating actions can be allowed or restricted.

According to one embodiment of the field device, the current operating phase is changed by the electronics unit when one or more of the following events occur:
Reception of an external control signal by the field device, in particular via a control line or a communication network, preferably a field bus system. The control signal is transmitted by an external unit and received by a communication interface of the field device. A control line is a connection, in particular a proprietary one, between an operating device and a field device, for example via the “CDI” interface offered by applicant. A fieldbus is a special communication network for an automation system. Known fieldbus protocols are for example HART, Foundation Fieldbus or Profibus, or an Ethernet-based fieldbus protocol such as Ethernet/IP. It can also be provided that the communication network or the control line is designed to be wireless and uses, for example, Bluetooth or WiFi as communication protocol
Dedicated selection or change of one of the operating phases by a user, in particular via an operating element of the field device. Such an operating element can be, for example, one or more buttons which are arranged on the housing of the field device. The display unit of the field device can also be designed as a display element if the display has touch functionality. Receiving an order ticket via a communication interface of the field device, which order ticket contains a command for changing the operating phases. An order ticket, as described for example in DE 10 2019 131 860 A1, contains or corresponds to a transaction. A transaction is a sequence of program steps that are considered a logical unit because they leave the data set in a consistent state after error-free and complete execution. In addition to the command to change the operating phases, order data for the work order to be carried out are defined in the order ticket. The order data may, for example, be the following data: unique identifier of the service employee or of the user, of the field device, of the work order, e.g., maintenance task, unlocking of a defined parameter, calibration, exchange of the field device, etc., and optionally of the time period in which the work order is to be performed. In addition, the order ticket can be encrypted so that it can only be opened and its content processed by the intended recipient.

It is also possible for the field device to change its operating phase depending on the time or date. For example, the field device is operated at night in a different operating phase than during the day. For example, at night only the night shift of the service technicians has access, but not the day shift, and vice versa.

In one embodiment of the field device, it is provided that the defined operating phases are at least two of the following:
A production phase, i.e., the phase in the life cycle of the field device in which the field device is produced and receives an initial configuration or parameterization.
An installation phase, i.e., the phase in the life cycle of the field device in which the field device is installed in the intended measuring location and receives the configuration or parameterization with which the field device can perform its intended tasks in the measuring location.
A phase of regular operation of the field device. In this phase, the field device fulfills its tasks, e.g., collecting measured values or influencing the variables of the process engineering process.
A phase of validated operation of the field device. It may be intended, for example if the field device performs measurement tasks that comprise high-value transactions (e.g., transfer of oil from a tanker as part of a custody transfer measuring location), that the measured values recorded by the field device must meet the required degree of accuracy.
A maintenance phase. In this phase, the field device is checked for errors and/or accuracy and/or errors in the field device are corrected.

According to an advantageous embodiment of the field device, it is provided that at least one operating action is one or more of the following:
A calibration of the field device. Here, the field device is set such that its measured values correspond to predetermined reference values under known conditions. Among other things, parameter values of the field device are set and/or changed for this purpose.
A configuration or parameterization of the field device. Among other things, parameter values of the field device are set and/or changed here.
A maintenance action on the field device or on a component of the field device. Components of the field device are replaced and/or repaired for this purpose. For this purpose, it can be provided to temporarily stop or restrict the operation of the field device.
Access to at least one communication interface of the field device. Here the communication interface is enabled for the user so that they can access the field device via the communication interface using another device and initiate further operating actions.
Access to the field device via at least one operating element. Here the operating element is enabled for the user so that they can access the field device via the operating device and initiate further operating actions.

A further embodiment of the field device provides that the users defined in the authorization information items and approved for access to the field device comprise at least one user group. It can thus be provided that not only dedicated individual users are defined in the authorization information items, but a plurality of users to whom a specific attribute or a specific property is assigned, for example production workers or service technicians. For example, during the installation phase the group of all tradesmen and service technicians could have access, but after the device approval only the group of all service technicians.

With regard to the method, it is provided that it serves for safe operation of a field device according to the invention. The method comprises the following method steps:
reception of an access request by the field device, wherein at least one item of information relating to a user and/or at least one operating action is contained in the access request;
checking whether the at least one piece of information relating to the user contained in the access request and/or the at least one operating action is contained in the authorization information items assigned to the current operating phase; and
allowing access to the field device in the event of a successful check.

The access request is only permitted if the check is successful. This means that the information items contained in the access request regarding the user and/or contained operating actions are actually contained in the authorization information items assigned to the current operating phase—for example, a user may perform certain operating actions on the field device if at least one of the authorization information items in which his information is contained is assigned to the current operating phase.

According to an advantageous embodiment of the method according to the invention, it is provided that the access request is contained in an order ticket. An order ticket, as described for example in DE 10 2019 131 860 A1, contains or corresponds to a transaction. A transaction is a sequence of program steps that are considered a logical unit because they leave the data set in a consistent state after error-free and complete execution. In addition to the command to change the operating phases, order data for the work order to be carried out are defined in the order ticket. The order data may, for example, be the following data: unique identifier of the service employee or of the user, of the field device, of the work order, e.g., maintenance task, unlocking of a defined parameter, calibration, exchange of the field device, etc., and optionally of the time period in which the work order is to be performed. In addition, the order ticket can be encrypted so that it can only be opened and its content processed by the intended recipient.

With regard to the access request, it is provided that it is created by a first external unit and transmitted to the field device.

In a first variant of the method, the first external unit is a computer unit, in particular a PC or a laptop, or a mobile terminal device, in particular a smartphone or a tablet. The operating unit here advantageously has a suitable operating program, for example an operating app when using a mobile terminal device (for example the “SmartBlue” app provided by applicant), or for example a frame application, which is designed in particular in accordance with the FDT standard, when using a computer unit as the first external unit (for example the FDT frame application “FieldCare” distributed by the applicant).

In particular, the first external unit transmits the access request to the field device via a wired or wireless communication connection. For example, a fieldbus is used for a wired communication connection. A fieldbus is a special communication network for an automation system. Known fieldbus protocols are for example HART, Foundation Fieldbus or Profibus, or an Ethernet-based fieldbus protocol such as Ethernet/IP. If the communication connection is wireless, Bluetooth or WiFi, for example, can be used as communication protocol.

In a second variant of the method, it is provided that the first external unit is an order server which creates the order ticket after a request from a user and transmits it to the field device, in particular via the Internet. The order server can be part of a cloud-based platform or a stand-alone server. A cloud-based platform (also known simply as a “cloud”) is a server to/from which data can be sent and received via the Internet and on which one or more applications are located. The order server can be implemented, for example, as an application on the cloud-based platform.

An advantageous embodiment of the method according to the invention provides that, in the course of the checking, it is additionally checked via which communication interface of the field device the access request was received, the access being allowed only if the user is authorized to access via this communication interface and/or if the execution of the operating action via this communication interface is permitted. For example, it may be provided that certain operating actions are only permitted via an operating unit, or via the first external unit, and the communication interface assigned to it on the field device and that access via other communication interfaces is not permitted, or vice versa.

One embodiment of the method provides for a confirmation ticket to be created by the field device after permitted access and transmitted to the first external unit or to a second external unit, the confirmation ticket containing an item of information about the current operating phase of the field device and about the operating action performed. For documentation in higher-level systems (e.g., ERP) for audits/inspectors/FDA or other external authorities (e.g., port inspector for proof of the correct function of a ballast water treatment plant), and for data integrity, the confirmation ticket contains the following data:
the serial number and the TAG of the field device and the connected sensor unit, or actuator unit.
the versions of the firmware of the field device and its components.
the date of the last calibration performed, as well as the calibration status of the field device and its sensor unit or actuator unit.
the current parameter set of the field device.

This reduces the documentation effort and at the same time increases data integrity, because the time stamp of the operating action performed on the field device is also contained in the confirmation ticket.

The second external unit can be a server or an application running on the cloud-based platform described above.

### BRIEF DESCRIPTION OF THE DRAWINGS

The invention is explained in greater detail with reference to the following figures. In the FIGURE:

FIG. 1 shows a first embodiment of a method in which a field device according to the invention is used.

### DETAILED DESCRIPTION

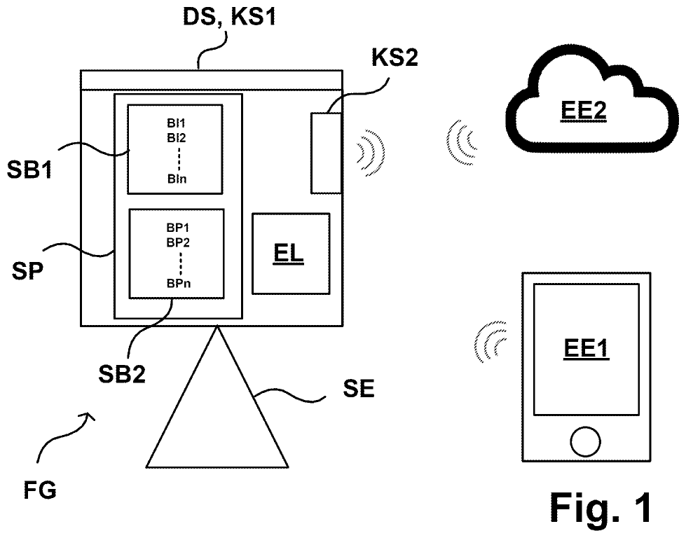

FIG. 1 schematically depicts a field device FG of automation technology. The field device FG is a radar measuring device for contactless detection of the fill level of a process medium in a container. For this purpose, a sensor SE is assigned to the measuring device, which both emits radar waves and detects reflected radar waves.

A plurality of authorization information items BI1, BI2, . . . , BIn are stored in a first memory area SB1 of a memory unit SP of the field device. The authorization information items BI1, BI2, . . . , BIn define the extent to which a user who wishes to operate the field device FG via an operating device BG (connected to the field device FG e.g., by wireless connection or by cable connection, in particular by fieldbus connection) or via an operating element (buttons and/or touchscreen on the display DS) attached directly to the field device FG can gain access to the field device FG. The authorization information items BI1, BI2, . . . , BIn contain users authorized for this, and/or operating actions permitted to the user. The operating actions are, for example, initiation of diagnostic tests, reading and/or setting parameter values, etc.

A plurality of operating phases BP1, BP2, . . . , BPn are stored in a second memory area SB2 of the memory unit SP. In addition to a display DS, the field device FG has an electronic unit EL which is designed to operate the field device FG. Operation means that the electronic unit EL executes a current operating phase, the current operating phase being selected from the operating phases BP1, BP2, . . . , BPn that are defined or are stored in the memory unit SP.

One or more authorization information items BI1, BI2, . . . , BIn are assigned to each of the operating phases BP1, BP2, . . . , BPn. This means that when the field device FG is operated in the current operating phase, only those users listed in the authorization information items assigned to the current operating phase can carry out only the listed operating actions. The access to the field device FG is thus controlled depending on the current operating phase.

The operating phases are switched for example by an external signal, e.g., triggered by a user who sends the signal to the field device via one of the communication interfaces KS1, KS2, or by an internal timer of the field device FG, e.g., a real-time clock (RTC).

An example of an access to the field device FG is described below:

The field device FG is currently being operated in the maintenance phase. In this maintenance phase, a recalibration of the sensor unit SE is to be carried out. The user wishes to access the field device FG via a first external unit EE1. The first external unit EE1, in the present case a mobile terminal device in the form of a smartphone, establishes a communication connection with a first communication interface KS1 of the field device FG via a wireless connection, for example Bluetooth or WiFi. The first external unit EE1 then sends an access request in an order ticket to the field device FG. The access request contains an identity of the user and the operating action to be performed (here: command to start the calibration).

The electronics unit EL compares the information contained in the access request with the authorization information items assigned to the current operating phase. Here it is determined that the user, as a service technician group, has a group authorization to access the FG field device and that the operating action is a permitted operating action. The field device FG then approves the access request and carries out the operating action and the associated recalibration.

Once the recalibration is complete, the FG field device creates a confirmation ticket containing a time stamp and an item of information about the operating action performed. The confirmation ticket is sent for documentation purposes via the first external unit EE1 or directly from the field device FG to a second external unit EE2, in this case a server.

If the user is not a service technician, the access request is not approved. Particular other operating actions can also be blocked. It can also be specified that access via other communication interfaces is blocked during this operating phase. For example, access via the communication interface KS2, which is the touchscreen of the display DS, is not enabled for the user.

Other application examples can also be realized:

For example, it can be provided that the described operating action of starting the calibration is permitted only in the operating phase of calibration, but not in an operating phase in which the field device FG starts operation and batch production is running in the process engineering process of the system.

It is also possible, for example, to provide that an operating action that starts the cleaning of the sensor element SE is possible only during non-critical production phases of the process. In such a case, a control unit of the fieldbus network sends a control signal to the field device FG to switch the current operating phase. In this operating phase, the recording of the measured value by means of the sensor unit SE is suspended, and the described operating action for cleaning the sensor element SE is permitted. In critical production phases, when the measured value is required continuously, the field device FG is operated in a current operating phase in which the described operating action for cleaning the sensor element SE is not permitted.

The invention is not limited by the listed exemplary embodiments and applications. It will be clear to the person skilled in the art that a plurality of further application examples can be assigned to the method according to the invention. The field device FG described in the embodiment examples is also to be regarded as only an example. The sensor SE can thus be designed in any way desired, so that the field device can be used for pressure and temperature measurement, conductivity measurement, flow measurement, pH measurement, fill level measurement, etc. The sensor SE does not have to be an integral component of the field device FG, but can also merely be assigned to it, e.g., can be located at a different location and have a cable connection to the field device (e.g., if the sensor SE is designed as a pH probe). As an alternative to a sensor SE, the field device FG can also have an actuator, e.g., a valve, a pump, etc., and can thus be designed to influence the aforementioned process variables.

1. A field device of automation technology, comprising:
wherein the field device has at least one sensor designed to detect a physical, chemical, or biological variable of a process engineering process and/or at least one actuator designed to influence a physical variable of a process engineering process, or such a sensor and/or actuator is assigned to the field device;
wherein the field device has at least one electronics unit for operating the field device, wherein at least two operating phases are defined in the field device;
wherein one or more authorization information items are assigned to each of the operating phases;
wherein the authorization information items define at least one user authorized to access the field device and/or at least one permitted operating action on the field device; and
wherein the electronics unit is designed to operate the field device in a current operating phase, wherein the current operating phase is one of the defined operating phases.

2. The field device according to claim 1, wherein the electronics unit is designed to check an access request to determine whether information items contained in the access request regarding the user and/or contained operating actions are contained in the authorization information items assigned to the current operating phase.

3. The field device according to claim 2, wherein the access request is only permitted in case of a successful check.

4. The field device according to claim 1, wherein the electronics unit is designed to change the current operating phase, wherein, in the course of changing, the current operating phase is replaced with one of the defined operating phases which is not the current operating phase.

5. The field device according to claim 1, wherein the electronics unit is designed to change the current operating phase when one or more of the following events occur:
reception of an external control signal by the field device, in particular via a control line or a communication network, preferably a fieldbus system;
dedicated selection or change of one of the operating phases by a user; and
receiving an order ticket via a communication interface of the field device, which order ticket contains a command for changing the operating phases.

6. The field device according to claim 1, wherein the defined operating phases are at least two of the following:
production phase;
installation phase;
regular operation;
validated operation; and
maintenance phase.

7. The field device according to claim 1, wherein the at least one operating action is one or more of the following:
a calibration of the field device;
a configuration or parameterization of the field device;
a maintenance action on the field device or on a component of the field device;
access to at least one communication interface of the field device; and
access to the field device via at least one operating element.

8. The field device according to claim 1, wherein the users defined in the authorization information items and authorized to access the field device comprise at least one user group.

9. A method for safe operation of a field device, comprising:
wherein the field device has at least one sensor designed to detect a physical, chemical, or biological variable of a process engineering process and/or at least one actuator designed to influence a physical variable of a process engineering process, or such a sensor and/or actuator is assigned to the field device;
wherein the field device has at least one electronics unit for operating the field device, wherein at least two operating phases are defined in the field device;
wherein one or more authorization information items are assigned to each of the operating phases;
wherein the authorization information items define at least one user authorized to access the field device and/or at least one permitted operating action on the field device; and wherein the electronics unit is designed to operate the field device in a current operating phase, wherein the current operating phase is one of the defined operating phases;
wherein the method includes the following steps:
reception of an access request by the field device, wherein at least one item of information relating to a user and/or at least one operating action is contained in the access request;
checking whether the at least one item of information contained in the access request relating to the user and/or the at least one operating action are contained in the authorization information items assigned to the current operating phase; and
allowing access to the field device in the event of a successful check.

10. The method according to claim 9, wherein the access request is contained in an order ticket.

11. The method according to claim 9, wherein the access request is created by a first external unit and transmitted to the field device.

12. The method according to claim 11, wherein the first external unit is a computer unit, in particular a PC or a laptop, or a mobile terminal device, in particular a smartphone or a tablet.

13. The method according to claim 12, wherein the first external unit transmits the access request via a wired or wireless communication connection to the field device.

14. The method according to claim 10, wherein the first external unit is an order server which, after request of a user, creates the order ticket and transmits it, in particular via the Internet, to the field device.

15. The method according to claim 9, wherein, in the course of the checking, it is additionally checked via which communication interface of the field device the access request has been received, wherein the access is only permitted if the user is authorized to access via this communication interface and/or if the execution of the operating action via this communication interface is permitted.

16. The method according to claim 9, wherein, after permitted access, a confirmation ticket is created by the field device and transmitted to the first external unit or to a second external unit, wherein the confirmation ticket contains an item of information about the current operating phase of the field device and about the executed operating action.
